(19) United States
(12) Patent Application Publication
(10) Pub. No.: US 2022/0136472 A1
(43) Pub. Date: May 5, 2022

(54) SEALING SLEEVE AND SEALING ARRANGEMENT HAVING SEALING SLEEVE

(71) Applicant: LIEBHERR-COMPONENTS DEGGENDORF GMBH, Deggendorf (DE)

(72) Inventors: Markus HOELLBACHER, Puch (AT); Fabian SCHMID, Deggendorf (DE)

(21) Appl. No.: 17/429,610

(22) PCT Filed: Feb. 5, 2020
(86) PCT No.: PCT/EP2020/052886

§ 371 Date: Aug. 9, 2021

(30) Foreign Application Priority Data
Feb. 11, 2019 (DE) 10 2019 103 351.9

(51) Int. Cl. F02M 53/04; F16J 15/06; B01D 29/03; B01D 29/56

(52) U.S. Cl. CPC F02M 53/04; B01D 29/56; B01D 29/035; F16J 15/064

(57) ABSTRACT

The present invention relates to a sealing sleeve for the separated supply and discharge of a cooling medium that comprises a sealing member that is pivotally symmetrical about the longitudinal axis, a protrusion projecting radially outwardly with respect to the longitudinal axis at the upper longitudinal end of the sleeve member, a protrusion projecting radially outwardly with respect to the longitudinal axis at the lower longitudinal end of the sleeve member, a first web section and a second web section of which each one extends in the axial direction of the sleeve member and connects the upper protrusion to the lower protrusion, and a first wall region and a second wall region of which each one is bounded in the axial direction by the upper and lower protrusions and in the peripheral direction by the first and second web sections and is radially inward offset with respect to these elements, with the upper protrusion and the lower protrusion each extending continuously around the total periphery of the sleeve member and defining its maximum radial extent, and with the first wall region and the second wall region each having a radially extending passage channel to radially supply or discharge a cooling medium.

### TECHNICAL FIELD

The present disclosure relates to a sealing sleeve and to a sealing arrangement provided with the sealing sleeve. The present disclosure further relates to a fuel injector that is to be cooled and that is provided with or cooperates with such a sealing sleeve.

### BACKGROUND AND SUMMARY

In accordance with the prior art, there is a large number of solutions for sealing a cooling fluid line. The respective inflow and outflow region of the member that is to be cooled and that has cooling fluid lines is separated by a plurality of sealing rings with the cooling fluid lines that extend in an elongate member and whose inflow and outflow are arranged at the jacket surface of the elongate member. There is here often the demand that the inflow line and the outflow line of a cooling fluid that are guided into or out of the member to be cooled are fluidically separate from one another so that there is an effective transporting away or introduction of the cooling fluid having different temperatures.

In this respect, grooves are required in the component to be cooled or in the component disposed opposite it that together define the required installation space for the axial positioning of the sealing ring.

It is furthermore necessary in accordance with the prior art that the inflow region is bounded by at least two O rings, whereby, however, a fluid connection of the inflow region extending around the total periphery of the elongate member is produced between the component to be cooled and the installation space of the component to be cooled. The same also applies here to the outflow region so that it is absolutely necessary to arrange the inflow region and the outflow region of the cooling fluid line of the elongate member offset from one another in the longitudinal direction. This also results in a relatively large-volume installation space of the sealing.

If a filtering of the cooling fluid is additionally desired, this takes place via separate filters in front of the sealing rings and the components to be cooled, which in turn expands the required construction space and increases the number of necessary components.

In accordance with the prior art, a high error potential results overall due to the plurality of sealing rings and grooves and the large number of different sealing regions and the components required for this that arises therefrom.

It is the aim of the present disclosure to alleviate or to overcome the above-listed disadvantages and to provide an improved sealing sleeve that takes up less construction space, is simultaneously less prone to disturbances in so doing, and additionally only comprises a very small number of necessary elements. Such a sealing sleeve simultaneously also results in reduced manufacturing costs due to the reduced product effort that accompanies it.

The sealing sleeve for the separated supply and discharge of a cooling medium accordingly comprises a sealing member that is pivotally symmetrical about its longitudinal axis, a protrusion projecting radially outwardly with respect to the longitudinal axis at the upper longitudinal end of the sleeve member, a protrusion projecting radially outwardly with respect to the longitudinal axis at the lower longitudinal end of the sleeve member, a first web section and a second web section of which each one extends in the axial direction of the sleeve member and connects the upper protrusion to the lower protrusion, and a first wall region a second wall region of which each one is bounded in the axial direction by the upper and lower protrusions and in the peripheral direction by the first and second web sections and is radially inwardly offset with respect to these elements, with the upper protrusion and the lower protrusion each extending continuously around the total periphery of the sleeve member and defining its maximum radial extent, and with the first wall region and the second wall region each having a radially extending passage channel to radially supply or discharge a cooling medium.

A sealing sleeve is therefore produced whose wall regions are radially inwardly set back with respect to the lower and upper protrusions and to the web sections extending in the longitudinal direction. The wall regions are therefore inwardly set back in the manner of steps viewed in the radial direction so that the two wall regions are separated from one another by the web section.

Chambers that are useable for the supply and discharge of a cooling fluid can thereby be formed on the application of an outer sleeve that surrounds the sealing sleeve in the peripheral direction and that contacts the outwardly projecting web section or the protrusions. For example, in the design of the sealing sleeve that both chambers are arrangeable at the same level in the axial direction of the sleeve member, but are provided at different peripheral regions of the sleeve. The frequently tight concentration space can thus be used efficiently.

The case is naturally also covered by the disclosure that there are more than two web sections, which would have the consequence of more than two wall regions. The underlying principle of the disclosure will, however, be recited in the following with reference to two web sections, with the presence of more than two web sections likewise being covered by the disclosure.

Provision is made that the first and second web sections each merge step-free into the upper and lower protrusions at their radially outer sides. A design is thereby achieved since a sealing of the outer periphery of the sealing sleeve can be easily effected.

Each wall region is accordingly bordered by a radially outwardly projecting web section at its lateral outer edges and by the radially outwardly projecting protrusion at its upper and lower edges.

The passage channel that is arranged in the wall region is a throughhole of the wall region in the radial direction so that a flow of a cooling fluid can take place from the radial inner side of the sealing sleeve toward its outer side or vice versa.

Provision is made in accordance with a further optional modification of the disclosure that the upper protrusion and the lower protrusion are identical and each define the maximum radial extent over the total periphery of the sealing member. Provision can additionally be made that the two protrusions do not have any mutual offset in the peripheral direction with respect to one another, that is they lie completely on one another along the longitudinal axis of the sleeve member.

Provision can furthermore also be made that the web sections are equidistantly spaced apart from one another in the peripheral direction of the nozzle member, that is are disposed opposite one another and have a distance of it (in a radian measure or 180° in degrees) on a presence of only two web sections. It can be generally said of the distance in the peripheral direction that with a number of n web sections, they are spaced apart from one another by 2π/n.

Provision is made in accordance with a further development of the disclosure that the first and second web sections furthermore each have a section that projects radially inwardly with respect to the wall regions and that extends from the upper protrusion toward the lower protrusion in the axial direction.

Provision can additionally be made here that the inwardly projecting sections of the first and second web sections define the minimal radial extent of the sleeve member. In other words, the radially inwardly projecting section of the at least two web sections therefore projects the furthest inwardly. These inwardly projecting sections are frequently used in conjunction with a corresponding groove at a member guided by the sealing sleeve for a correct positioning of the sealing sleeve, but in this process typically simultaneously have the object of fluidically separating the different wall regions at an inner side of the sealing sleeve.

Provision is made in accordance with a modification that the inwardly projecting sections of the first and second web sections, offset in the radial direction, which may be offset in a step-like manner, start from the upper and lower projections. Different than at the outer periphery of the sealing sleeve—there is accordingly a difference in the radial position of the inwardly projecting section of an associated web section and of the inwardly projecting section of the protrusions. The section of the web sections can here project radially inwardly in a step-like manner from the protrusion.

Provision is made in accordance with the disclosure that the first and second wall regions are radially outwardly offset with respect to the radially inwardly projecting section of the upper and lower protrusions and with respect to the radially inwardly projecting section of the first and second web sections so that the first and second wall regions are outwardly arranged offset from these elements, in a step-like manner outwardly in the radial direction.

The inner side of the wall region is thereby bordered—just as on the outer side—by radially inwardly projecting elements at its edges. A chamber can thus also be formed here, on the leading of a correspondingly shaped member through the sealing sleeve, which chamber is bounded by the radially inwardly projecting sections of the web sections and of the protrusions and the wall region at the inner side.

Provision can be made in accordance with an optional modification of the disclosure that the at least one radially extending passage channel is provided with a filter in each of the wall regions to filter cooling fluid flowing through the passage channel.

This is of advantage to the extent that now already filtered cooling liquid no longer has to be supplied, but the filtering rather takes place by means of the sealing sleeve itself. This saves elements and thus reduces the required construction space.

Provision can furthermore be made that the sleeve member has the general shape of a cylinder, of a square, of a hexagon, or of a polygon and/or that the sleeve member has a sectional profile in an I shape, a C shape, an E shape or a U shape outside the web sections.

Provision can also be made that the envelope of the sealing sleeve or of the sleeve member has the shape of a cylinder, a square, a hexagon, or a polygon. A cooperation with a supply sleeve that surrounds the sealing sleeve and that has an inner cutout in one of the above-named shapes is thereby possible in a simple manner.

The disclosure further relates to a sealing arrangement having a sealing sleeve in accordance with one of the preceding variants, with the sealing arrangement further comprising a member to be cooled that extends through the interior of the sealing sleeve and has a first cooling fluid channel and a second cooling fluid channel, with the sealing sleeve being arranged at the member to be cooled such that an opening of the first cooling fluid channel is covered by the first wall region and an opening of the second cooling fluid channel is covered by the second wall region.

Provision is made here that the sealing sleeve only contacts the member to be cooled with the inwardly projecting sections of the upper and lower protrusions and with the inwardly projecting sections of the web sections so that a first chamber for receiving cooling fluid is formed between the member to be cooled and the first wall region and a second chamber for receiving cooling fluid is formed between the member to be cooled and the second wall region and the first chamber and the second chamber are fluidically separated from one another, with the exception of via a connection through the cooling fluid channels of the member to be cooled, due to the web sections acting as a separating element.

The fluidic separation is here achieved by the contacting of the sealing sleeve with the member to be cooled. If therefore a cooling fluid flows radially inwardly through the passage of a wall region, the chamber formed by the inwardly projecting sections of the web sections and of the protrusions is filled so that cooling fluid flows into the opening of the cooling fluid channel covered by the chamber in the member to be cooled.

It then similarly applies in the other chamber that likewise cooperates with the opening of a cooling fluid channel. If thermally heated cooling fluid flows out there, it collects in its chamber that is at times defined by the wall region arranged there and that can flow out through the passage channel. Since the chambers cooperating with the different openings of the cooling fluid channels are fluidically separated from one another, there is no intermixing of cooling fluids of different temperatures so that the cooling of the member to be cooled is very effective.

Provision is made in accordance with an optional modification that the sealing arrangement is further provided with a supply sleeve that is adapted to the outer contour of the sealing sleeve and that completely surrounds the sealing sleeve at the peripheral side and is provided with a coolant inflow and a coolant outflow in the supply sleeve, with the sealing sleeve being aligned with respect to the supply sleeve such that the coolant inflow and the coolant outflow are each covered by a respective wall region, the sealing sleeve only contacts the supply sleeve with the outwardly projecting sections of the upper and lower protrusions and with the outwardly projecting sections of the web sections such that a first supply chamber for receiving cooling fluid is formed between the supply sleeve and the first wall region and a second supply chamber for receiving cooling fluid is formed between the supply sleeve and the second wall region, and the first supply chamber and the second supply chamber are fluidically separated from one another, except for via a connection through the cooling fluid channels of the member to be cooled, due to the web sections acting as a separating element.

It is thus possible in a simple manner to provide a supply line and a discharge line to the cooling fluid channels of the member to be cooled. It is in this respect also very compact since the supply line and the discharge line of cooling fluid in the supply line only have to be spaced apart from one another at the peripheral side and not also in the longitudinal direction of the supply sleeve.

Provision can further be made that the member to be cooled has a corresponding groove-like notch for each of the inwardly radially projecting web sections of the sealing sleeve for its reception.

A simple assembly of the sealing sleeve at a member to be cooled can thus be achieved so that an assembly error in the correct alignment of the sealing sleeve with respect to the member to be cooled is precluded.

The disclosure also relates to a coolable fuel injector having a sealing sleeve in accordance with one of the preceding variants or a sealing arrangement in accordance with one of the preceding variants.

Page 6

### BRIEF DESCRIPTION OF THE FIGURES

Further features, details and advantages of the disclosure will become clear with reference to the following description of the Figures. There are shown:

FIG. 1: a perspective view of the sealing sleeve in accordance with the disclosure;

FIG. 2: a sectional view of the sealing sleeve in accordance with the disclosure;

FIG. 3: a further sectional view of the sealing sleeve in accordance with the disclosure through the two web sections;

FIG. 4: two sectional views of the sealing sleeve in accordance with the disclosure in accordance with a further embodiment;

FIG. 5: a sectional view of the sealing arrangement in accordance with the disclosure;

FIG. 6: a plan view of the seating arrangement in accordance with the disclosure;

FIG. 7: a sectional views of the sealing arrangement in accordance with the disclosure in accordance with a further embodiment;

FIG. 8: a plan view of the seating arrangement in accordance with the disclosure in accordance with the further embodiment;

FIG. 9: a sectional view of the sealing arrangement in accordance with the disclosure rotated by 90° about the longitudinal axis of the sealing arrangement with respect to FIG. 5 and FIG. 7 respectively;

FIG. 10: a perspective view of the sealing arrangement in accordance with the disclosure in a cut-away state; and

FIG. 11: a perspective sectional view of the seating arrangement in accordance with the disclosure in accordance with the further embodiment.

### DETAILED DESCRIPTION

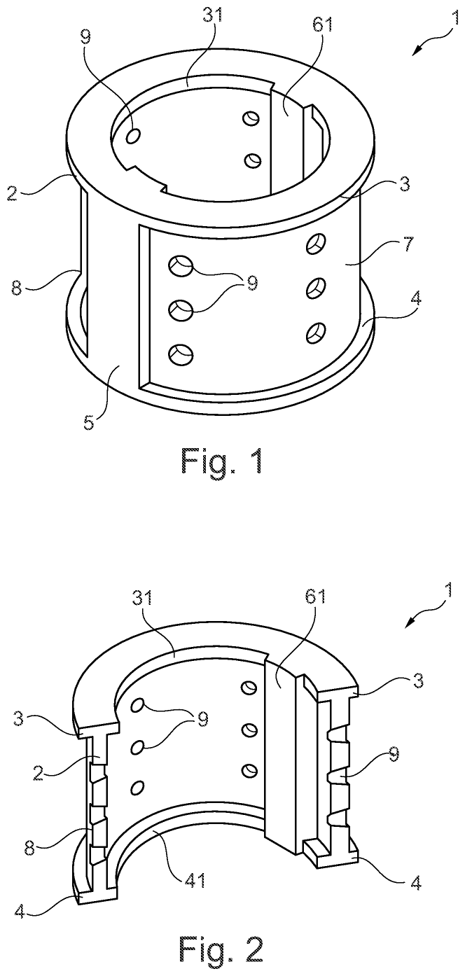

FIG. 1 shows a perspective representation of the sealing sleeve 1 in accordance with the disclosure. The substantially cylindrically base shape of the sealing member 2 can be recognized. The envelope of the sealing sleeve is a cylinder in this case.

The sleeve member 2 here has a respective outwardly projecting protrusion 3, 4 at its upper and at its lower longitudinal ends. In addition, there are two web sections 4, 5 that connect the protrusions 3, 4, to one another in the axial direction of the sleeve member 2. The transition from the radially outer region of the protrusions 3, 4 to the web sections 4, 5 is here stepless or smooth.

A first wall region 7 and a second wall region 8, that is penetrated by a respective at least one passage channel 9 in the radial direction, are provided radially or inwardly offset with respect to the protrusions 3, 4 and the web sections 4, 5.

Further sections 31, 41 project radially inwardly from the wall regions 7, 8 at the level of the protrusions 3, 4 on the inner side of the sleeve 1. Sections 51, 61 also project radially inwardly at the same peripheral positions as the web sections 5, 6. The sections 51, 61 projecting inwardly from the web sections 5, 6 here project further into the interior than the inwardly projecting sections 31, 41 of the protrusions 3, 4. The upper side of the sealing sleeve and also its lower side can here have the shape of a circular ring.

FIG. 2 shows a sectional view of the sealing sleeve explained in FIG. 1. It can be recognized that the sealing sleeve 1 has, outside the web sections 5, 6, an I shape in section that is only interrupted in the illustration by the passage channels 9 arranged above one another.

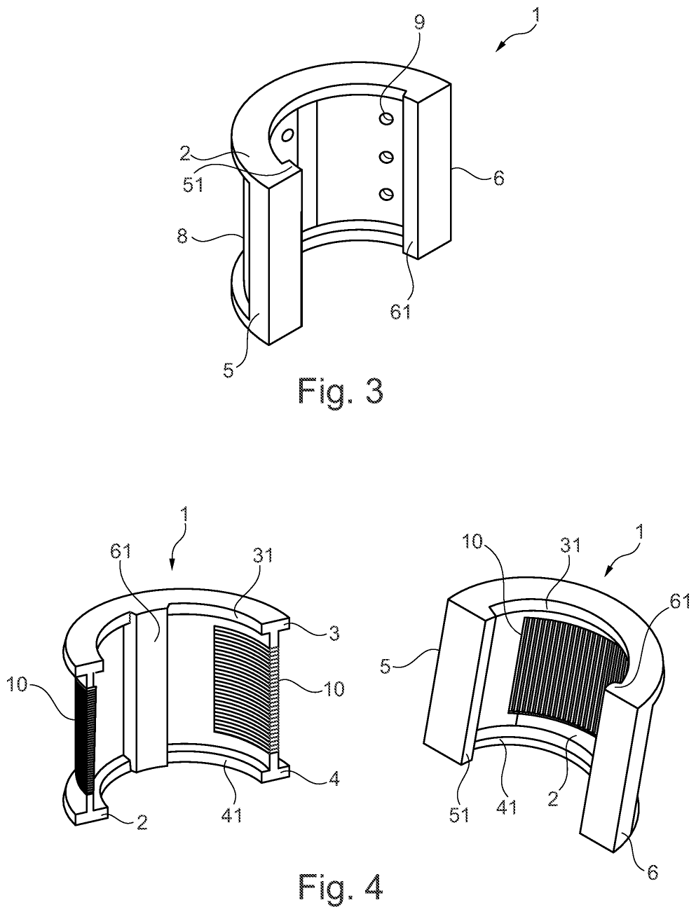

FIG. 3 shows an alternative sectional view to this that extends through the two oppositely disposed web sections 5, 6.

FIG. 4 shows two sectional views of a further embodiment of the sealing sleeve 1 in accordance with the disclosure in which a large-area passage channel is provided with a filter 10 instead of a plurality of passage channels 9. The filter can here be formed as a net-like structure or as rigid.

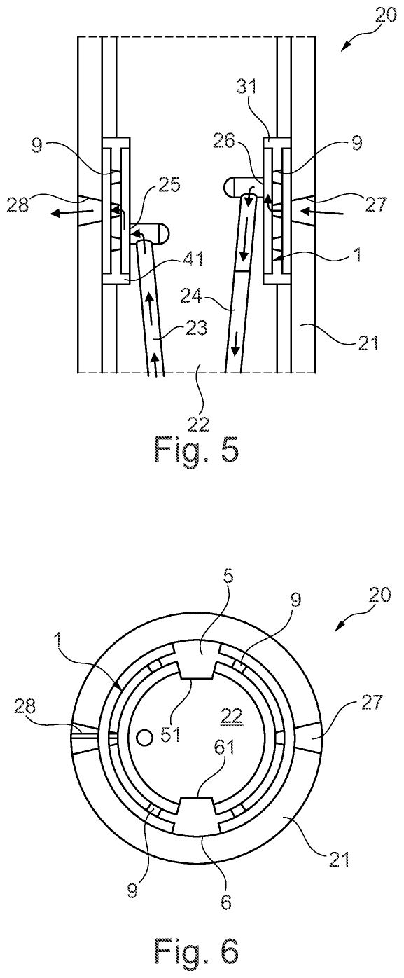

FIG. 5 shows a view along a longitudinal section of a sealing arrangement 20 that has, beside the sealing sleeve 1, a sealing member 22 guided through the sleeve 1 and has a supply sleeve 21 surrounding the sleeve 1 at the peripheral side. The member 22 to be cooled here has corresponding grooves at the inwardly projecting sections 51, 61 so that these sections 51, 61, like also the inwardly projecting sections 31, 41 of the protrusions 3, 4, contact the cooling member 22, which can be continuously in the peripheral direction.

The same applies to the supply sleeve 31 that contacts the outwardly projecting elements, namely the protrusions 3, 4 and the web sections 3, 4. Chambers that can be used for introducing or draining cooling fluid in cooling fluid channels 23, 34 are thereby produced in the intermediate space between the supply sleeve 21 and the sealing sleeve that are separated from one another by the web sections 3, 4 at the peripheral side. The openings 25, 25 of the cooling fluid channels 23, 24 are only to be arranged in an overlap region with a wall section directed toward the inner side for this purpose. An exemplary flow direction of a cooling fluid can be recognized with reference to the arrows. In this respect, cool cooling fluid is first introduced and cooling fluid is discharged after a cooling procedure at its elevated temperature.

FIG. 6 is a plan view of the sealing arrangement 20 of FIG. 5.

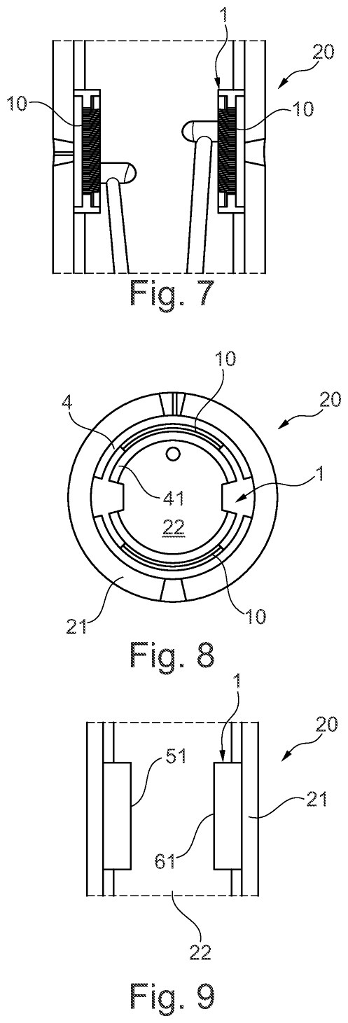

FIG. 7 is a view along a longitudinal section of a sealing arrangement 20 in which the sealing sleeve has a filter 10 instead of a plurality of passage channels 9. The active principle, however, is similar to that of the above-described embodiment.

FIG. 8 is a plan view of the sealing arrangement 20 of FIG. 7.

FIG. 9 is a view rotated by 90° about the longitudinal axis of the sealing arrangement 20 in comparison with FIGS. 5 and 7. It can be very easily recognized here that the inwardly projecting sections 51, 61 cooperate with corresponding groove-like cutouts of the member to be cooled.

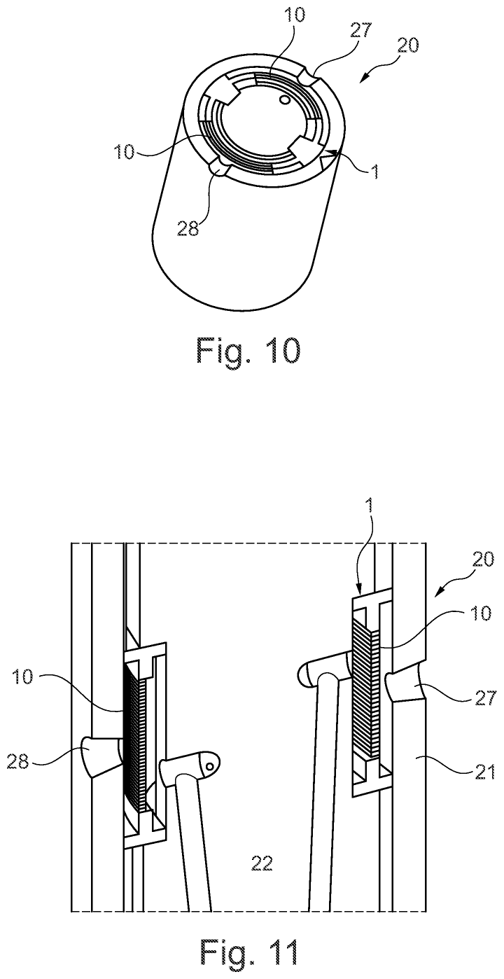

FIG. 10 is a perspective view of a cut-away sealing arrangement 20 that has a filter 10 in each of the two wall regions 7, 8 instead of the passage channels 9.

FIG. 11 likewise shows a sectional view similar to that of FIG. 5, but now with a sealing sleeve that has a filter 10 instead of the passage channels 9.

FIGS. 1-11 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A sealing sleeve for separated supply and discharge of a cooling medium comprising:
a sleeve member that is pivotably symmetrical about its longitudinal axis;
a protrusion projecting radially outwardly with respect to the longitudinal axis at an upper end of the sleeve member;
a protrusion projecting radially outwardly with respect to the longitudinal axis at its lower longitudinal end of the sleeve member;
a first and a second web section of which each one extends in an axial direction of the sleeve member and connects an upper protrusion to a lower protrusion; and
a first wall region and a second wall region of which each is bounded by the upper and lower protrusions in the axial direction and by the first and second web sections in a peripheral direction and is radially inwardly offset with respect to these elements, wherein
the upper protrusion and the lower protrusion each extend continuously around a total periphery of the sleeve member and define its maximum radial extent; and
the first wall region and the second wall region each have at least one radially extending passage channel to radially supply or discharge the cooling medium.

2. The sealing sleeve in accordance with claim 1, wherein the first and second web sections each merge step-free into the upper and lower protrusions at their radially outer sides.

3. The sealing sleeve in accordance with claim 1, wherein the upper protrusion and the lower protrusion are identical and each define the maximum radial extent over a total periphery of the sealing member.

4. The sealing sleeve in accordance with claim 1, wherein the upper protrusion and the lower protrusion furthermore each have a section projecting radially inwardly with respect to the first and second wall regions.

5. The sealing sleeve in accordance with claim 4, wherein the first and second web sections furthermore each have a section that projects radially inwardly with respect to the first and second wall regions and that extends from the upper protrusion toward the lower protrusion in the axial direction.

6. The sealing sleeve in accordance with claim 1, wherein the inwardly projecting sections of the first and second web sections define a minimal radial extent of the sleeve member.

7. The sealing sleeve in accordance with claims 6, wherein the inwardly projecting sections of the first and second web sections start from the upper and lower protrusions offset in a step-like manner in the radial direction.

8. The sealing sleeve in accordance with claim 7, wherein the first and second wall regions are radially outwardly offset with respect to the radially inwardly projecting section of the upper and lower protrusions and with respect to the radially inwardly projecting section of the first and second web sections so that the first and second wall regions are outwardly arranged offset from these elements in a step-like manner in the radial direction.

9. The sealing sleeve in accordance with claim 4, wherein the at least one radially extending passage channel is provided with a filter in each of the first and second wall regions to filter a cooling fluid flowing through the passage channel.

10. The sealing sleeve in accordance with claim 1, wherein
the sleeve member has a general shape of a cylinder, a square, a hexagon, or a polygon; and/or
the sleeve member has, outside the first and second web sections, a sectional profile in I shape, in C shape, in E shape, or in U shape.

11. The sealing arrangement having a sealing sleeve in accordance with claim 6 further comprising:
a member to be cooled that extends through an interior of the sealing sleeve and has a first cooling fluid channel and a second cooling fluid channel, wherein
the sealing sleeve is arranged at the member to be cooled such that an opening of the first cooling fluid channel is covered by the first wall region and an opening of the second cooling fluid channel is covered by the second wall region.

12. The sealing arrangement in accordance with claim 11, further having a sealing sleeve, wherein
the sealing sleeve only contacts the member to be cooled with the inwardly projecting sections of the upper and lower protrusions and with the inwardly projecting sections of the web sections so that a first chamber for receiving cooling fluid is formed between the member to be cooled and the first wall region and a second chamber for receiving cooling fluid is formed between the member to be cooled and the second wall region; and
the first chamber and the second chamber are fluidically separated from one another, apart from via a connection through the first and second cooling fluid channels of the member to be cooled, due to the web sections acting as a separating element.

13. The sealing arrangement in accordance with claim 12, further having
a supply sleeve that is adapted to an outer contour of the sealing sleeve and that completely surrounds the sealing sleeve at a peripheral side; and
a coolant inflow and a coolant outflow in the supply sleeve, wherein
the sealing sleeve is oriented with respect to the supply sleeve such that the coolant inflow and the coolant outflow are each covered by a respective wall region;
the sealing sleeve only contacts the supply sleeve with the outwardly projecting sections of the upper and lower protrusions and with the outwardly projecting sections of the web sections so that a first supply chamber for receiving cooling fluid is formed between the supply sleeve and the first wall region and a second supply chamber for receiving cooling fluid is formed between the supply sleeve and the second wall region; and
the first supply chamber and the second supply chamber are fluidically separated from one another, apart from via a connection through the cooling fluid channels of the member to be cooled, due to the web sections acting as a separating element.

14. The sealing arrangement in accordance with claim 11, wherein the member to be cooled has a corresponding groove-shaped notch for each of the inwardly radially projecting web sections of the sealing sleeve for its reception.

15. A coolable fuel injector having the sealing sleeve in accordance with claim 1.

16. The coolable fuel injector having the sealing arrangement in accordance with claim 11.
